(19) United States
(12) Patent Application Publication
(10) Pub. No.: US 2005/0176284 A1
(43) Pub. Date: Aug. 11, 2005

(54) Card edge connector

(76) Inventor: Ching-Chia Chu, Panchiao City (TW)

Correspondence Address: MOLEX INCORPORATED, 2222 WELLINGTON COURT, LISLE, IL, 60532, US

(21) Appl. No.: 11/035,550

(22) Filed: Jan. 14, 2005

(30) Foreign Application Priority Data
Jan. 16, 2004 (TW) 93200927

(51) Int. Cl. H01R 13/62

(52) U.S. Cl. 439/327

(57) ABSTRACT

A card edge connector includes an insulative housing, a plurality of terminals and two latches. The insulative housing has a main body and two lateral side frames, each lateral side has a concave groove formed thereon. The terminals are disposed on the main body. The two latches individually are disposed on two free ends of the two lateral side frames, and has two base portions. Wherein each base portion has a limiting tab extended from a front side of the base portion, an elastic arm connected with a rear side of the base portion, and the limiting tab is inserted into the concave groove. When the two lateral side frames are pushed outwardly, the two lateral side frames push the elastic arms to move outwardly, and the limiting tab interferes with the concave groove for limiting an outward pushing distance of the two lateral frames.

### FIELD OF THE INVENTION

The present invention relates to a card edge connector, and particularly relates to a card edge connector disposed on a motherboard for receiving and electrically connecting to a daughterboard.

### BACKGROUND OF THE INVENTION

Referring to FIGS. 1 and 2, a conventional card edge connector, disposed on an upper surface of a motherboard, is disclosed. The card edge connector is used for receiving a daughterboard so as to electrically connect the motherboard.

The card edge connector includes an insulative housing 91, a plurality of terminals 92 and two latches 93. The insulative housing 91 includes a main body 911 and two lateral frames 912 connecting the main body 911. The terminals 92 are arranged on the main body 911 of the insulative housing 91, and each of the terminals 92 has a pin portion 921 connecting to a pad of the motherboard for electrical connection. When the daughterboard inserts between the two lateral frames 912 of the insulative housing 91, the daughterboard electrically connects the terminals 92. Each of the two lateral frames 912 has a latching arm 913 formed at a free end thereof for resiliently locking the daughterboard.

The two latches 93 are disposed on the two lateral frames 912, and are made of the metallic materials. Each latch 93 has a main portion 931, which is shaped like U in order to match each lateral frame 912. The main portion 931 extends forwards and a limited portion 932 projecting upwardly is formed, so that the lateral sidewall of the main portion 931 and the limited portion 932 restrain the outward and inward distances of the two lateral frames 912, respectively.

However, the latches 93 of the conventional card edge connector are elongated, so that the sidewall of the main portion 931 of the two latches 93 cannot restrain the outward distance of the two lateral frames 912 exactly when the daughterboard is ejected and the two lateral frames 912 are moved outwardly so as to enable the latching arm 913 to be removed from the daughterboard. The two lateral frames 912 move outwardly and vibrate so much that they may lead to the deformation or breakage of the two lateral frames 912, which are made of plastic materials.

### SUMMARY OF THE INVENTION

One object of the invention is therefore to specify a card edge connector that can stop two lateral lateral frames in order to prevent the breakage or deformation of the two lateral frames when the two lateral frames are move outwardly.

In order to achieve the above objective, the present invention provides a card edge connector includes an insulative housing, a plurality of terminals and two latches. The insulative housing has a main body and two lateral side frames, each lateral side has a concave groove formed at bottom face and a front side thereof. The terminals are disposed on the main body of the insulative housing. The two latches individually are disposed on a free end of the two lateral side frames of the insulative housing, and has two base portions. Wherein each base portion has a limiting tab extended from a front side of the base portion, an elastic arm connected with a rear side of the base portion, and the limiting tab is inserted into the concave groove. Whereby, when the two lateral side frames are pushed outwardly, the two lateral side frames push the elastic arms to move outwardly, and the limiting tab interferes with the concave groove for limiting the outward pushing distance of the two lateral frames.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a card edge connector of the prior art;

FIG. 2 is a front view of a card edge connector of the prior art;

FIG. 3 is a perspective, exploded view of a card edge connector of the present invention;

FIG. 4 is a perspective, assembled view of a card edge connector of the present invention;

FIG. 5 is a front view of a card edge connector of the present invention; and

FIG. 6 is a bottom view of a card edge connector of the present invention.

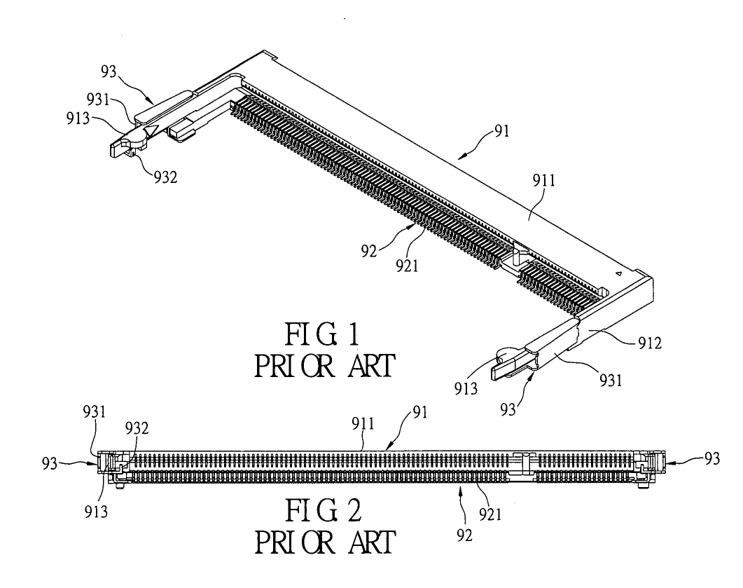

### DETAILED DESCRIPTION OF DISCLOSED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

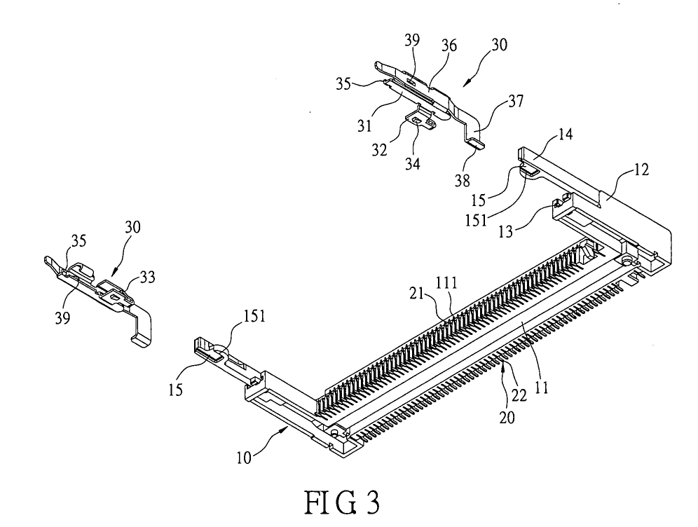

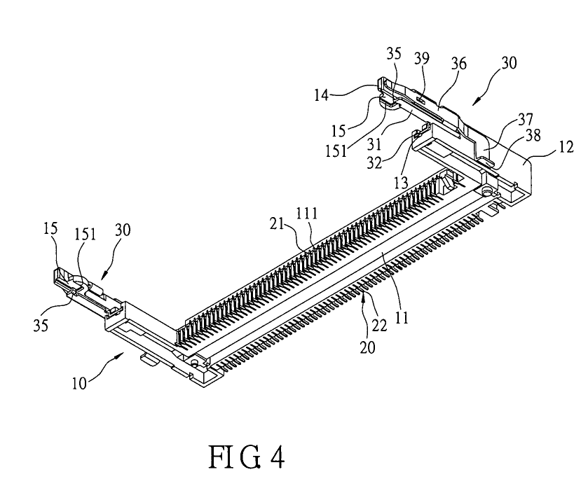

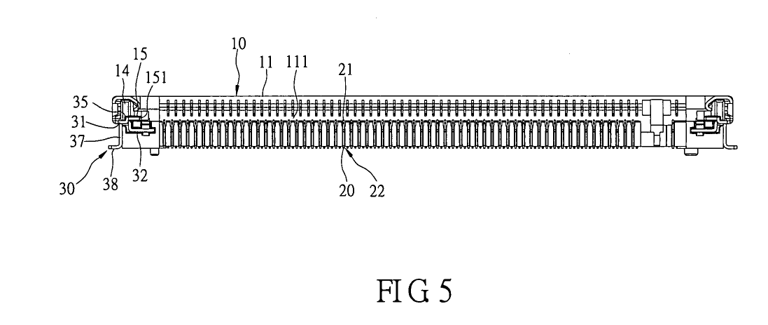

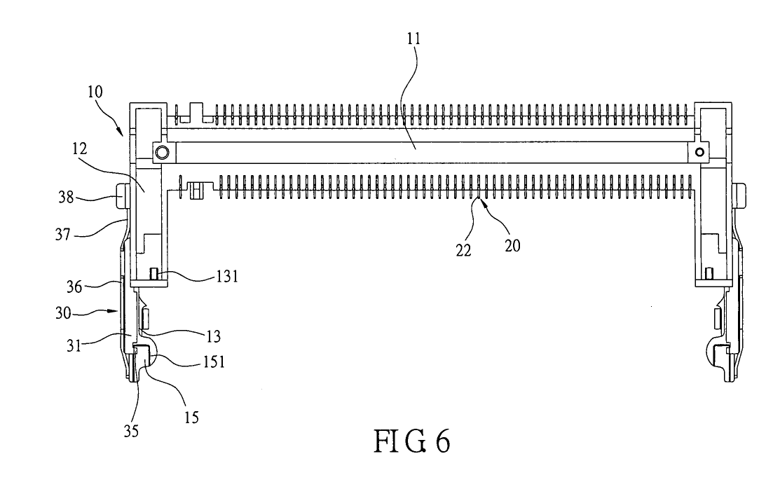

A card edge connector illustrated in FIGS. 3-6 according to the present invention is disposed on an upper surface of a motherboard for receiving and electrically connecting a daughterboard.

The card edge connector includes an insulative housing 10, a plurality of terminals 20 and two latches 30. The insulative housing 10 is made of plastic materials, and includes a main body 11 and two lateral frames 12 connecting the main body 11. The main body 11 includes a reception opening 111 for receiving one side of the daughterboard. Each lateral frame 12 has a slot 13 formed thereon, a latching arm 14 disposed on a free end thereof for securing the daughterboard resiliently, and a concave groove 15 formed at a front side and bottom side thereof. The concave groove 15 has a stopper 151 formed at an inner edge thereof.

The terminals 20 are disposed on the main body 11 of the insulative housing 10; each of the terminals 20 includes a contact portion 21 and a pin portion 22. The contact portion 21 is disposed inside the reception opening 111 of the insulative housing 11 for electrically connecting a pad of the daughterboard. The pin portion 22 extends outwardly from the main body 11 for soldering with a pad of the motherboard for electrical connection.

The latches 30 are individually mounted on a free end of two lateral frames 12 of the insulative housing 10. The latch 30 is punched by metallic material. Each latch 30 includes a base portion 31, which is elongated. The base portion 31 has a connection portion 32 extended from an inner side thereof to receive in the slots 13 of the two lateral frames 12. Each of the latches 30 includes a contact portion 33 upward extended and bended from the connection portion 32, and projected outside the slot 13 for electrically contacting to a bottom surface of the daughterboard. The connection portion 32 is punched downward to form a protrusion 34 to retain in a corresponding positioning hole 131 of the slot 13.

Each of the latches 30 has a limiting tab 35 extended from a front side of the base portion 31. The limiting tab 35 is inserted into the concave groove 15 for restraining the inward distance of the lateral frame 12. Each of the latches 30 has an elastic arm 36 connected with a rear side of the base portion 31. The elastic arm 36 has a free end that can be moved inwardly and outwardly.

Each of the latches 30 has an interference portion 39 formed on a central portion of the elastic arm 36 by punching. The interference portion 39 is projected from an inner wall of the elastic arm 36. The interference portion 39 contacts an external side of the lateral frame 12 to form a new fulcrum. An extended arm 37 connects with the rear side of the base portion 31. A retainer portion 38 is downward extended from the extension arm 37. The retainer portion 38 can be soldered on an upper surface of the motherboard for the latch 30 electrically connecting with the motherboard. Therefore, the daughterboard is grounded.

The pin portion 22 of each terminal 20 and the retainer portion 38 of each latch 30 solder to the upper surface of the motherboard for electrical connection. When the daughterboard inserts into the reception opening 111 of the insulative housing 10, the pin portion 21 of each contact 20 electrically connects the daughterboard, so as to enable the daughterboard to electrically connect the motherboard.

When the user wants to eject the daughterboard, the two lateral frames 12 can be moved outwardly to release the daughterboard from the latching arm 14 for removing the daughterboard easily. When the two lateral frames 12 push the elastic arms 36 to outwardly move a predetermined distance, the stopper 151 of the concave groove 15 interferes with the limiting tab 35 for positioning. Because the limiting tab 35 and the base portion 31 are fixed on the lateral frame 12 of the insulative housing 10, the stopper 151 interferes with the limiting tab 35 for limiting the outward pushing distance of the two lateral frames 12. Therefore, the two lateral frames 12 cannot be over extended, and the present invention can prevent the two lateral frames 12 from deforming or breaking.

Moreover, the interference portion 39 interferes with an outer side of the lateral frame 12 to form a new fulcrum. When the two lateral frames 12 are pushed outwardly, the two outer sides of the two lateral frames 12 interfere with the interference portion 39 for pushing the elastic arm 36 of the latch 30 to move outwardly. Therefore, the latch 30 is certainly released from the dautherboard, so as to enable the removal out the dautherboard.

While a preferred embodiment of the present invention is shown and described, it is envisioned that those skilled in the art may devise various modifications of the present invention without departing from the spirit and scope of the appended claims.

1. A card edge connector comprising:
an insulative housing having a main body and at least one lateral side frame extending in a direction away from the main body, a free end of the lateral side frame being located furthest away from the main body, the lateral side frame having a concave groove formed at a bottom face of the lateral side frame;
a plurality of terminals disposed on the main body of the insulative housing; and
a latch disposed on the free end of the lateral side frame of the insulative housing, the latch including a base portion, the base portion having a limiting tab extending from a front side of the base portion, an elastic arm connected with a rear side of the base portion, the limiting tab being inserted into the concave groove; and
whereby when the lateral side frame is extended outwardly, the lateral side frame extends the corresponding elastic arms outwardly, and the limiting tab interferes with the concave groove, thereby limiting the outwardly extending distance of the lateral side frame.

2. The card edge connector as claimed in claim 1, wherein the main body has a reception opening, and the lateral side frame has a latching arm disposed on the free end thereof.

3. The card edge connector as claimed in claim 1, wherein the main portions has a solder portion extended from an inner side thereof for connecting a motherboard.

4. The card edge connector as claimed in claim 1, wherein the lateral side frame has a slot formed thereon, the latch has a connection portion extended from an inner side of the base portion, the connection portion being received within the slot and a contact portion extends upward and is bent from the connection portion and projects outside the corresponding slot.

5. The card edge connector as claimed in claim 1, wherein the latch has an interference portion projected from an inner wall of the elastic arm, the interference portion contacts to an external side of the lateral frame.

6. The card edge connector as claimed in claim 1, wherein the latch has an extended arm connected with a rear side of the base portion, and a retainer portion is downward extended from the extension arm.

7. The card edge connector as claimed in claim 1, wherein the insulative housing has two lateral side frames.

8. The card edge connector as claimed in claim 7, wherein each of the lateral side frames include a latch.

9. The card edge connector as claimed in claim 7, wherein the insulative housing includes a main body, and wherein the main body is located between the two lateral side frames.
